(19) United States
(12) Patent Application Publication
(10) Pub. No.: US 2009/0026905 A1
(43) Pub. Date: Jan. 29, 2009

(54) AUTOMATIC STORAGE DEVICE AND CLIMATE CONTROLLED CABINET FOR LABORATORY OBJECTS

(76) Inventor: Cosmas G. Malin, Mauren (LI)

Correspondence Address: BROWDY AND NEIMARK, P.L.L.C.;624 NINTH STREET, NW, SUITE 300, WASHINGTON, DC, 20001-5303, US

(21) Appl. No.: 11/814,065

(22) PCT Filed: Jan. 12, 2006
(86) PCT No.: PCT/CH06/00029

§ 371 Date: Apr. 28, 2008

(30) Foreign Application Priority Data
Jan. 12, 2005 (DE) 10 2005 001 888.2
Jan. 28, 2005 (CH) 135/05

(51) Int. Cl. A47B 96/00; A47B 95/00; A47F 5/00; B66C 3/00

(52) U.S. Cl. 312/400; 312/321; 211/153; 414/729

(57) ABSTRACT

A storage device in particular for a climate controlled cabinet is described. The storage device serves to store laboratory objects, in particular microtiter plates, in shelf racks (4) and comprises a shelf access device, which has an upper and a lower guide (15, 15′), between which there is arranged a vertical guide (16). A horizontal drive (18) drives the vertical guide (16) along the upper horizontal guide (15). A shaft transmits this motion to the lower end of the vertical guide (16) and drives a gear there, which generates an additional drive along the lower guide (15′). This allows to prevent a tilting of the vertical guide (16) when accelerating or decelerating. In addition, the vertical guide (15) is guided in non-rotational manner at its upper and lower ends in the upper and lower guides (15, 15′), such that a torsion of the vertical guide is prevented.

### REFERENCE TO RELATED APPLICATIONS

This application claims the priority of the German patent application 10 2005 001 888, filed Jan. 14, 2005, as well as Swiss patent application no. 00135/05, filed Jan. 28, 2005. The whole disclosure of these two applications is incorporated herein by reference.

### BACKGROUND

The present invention refers to an automatic storage device and a climate controlled cabinet for receiving laboratory objects, in particular microtiter-plates.

In chemical, pharmaceutical and biological research large amounts of samples have to be tested, manipulated and stored. The storage of the samples often occurs in so-called microtiter-plates, which comprise a plurality of fine receiving recesses for the samples. Microtiter-plates have, as a rule, a standardised size with a footprint of approximately 127.76 millimetres×85.48 millimeters (each +/−0.5 millimetres) according to standard ANSI/SPS 1-2004, Jan. 8, 2004, “for microplates—Footprint Dimensions”, and a plurality of devices has been provided for storing such plates or similar laboratory objects, such as so-called laboratory flasks.

EP 1 332 987 describes a storage device with a storage alley with two shelf racks arranged along the storage alley and a shelf access device displaceable along the storage alley. The shelf access device comprises a pickup device that is adjustable in height and extendible, by means of which laboratory objects stored in the shelf racks can be picked up. In particular for high shelf racks, care must be taken in such plants in order for the shelf rack and the shelf access device to be sufficiently stable, such that vibrations and in particular an undesired tilting and/or a torsion of the components are avoided. This increases, however, the weight of the components, which makes the construction more expensive and reduces the speed of the plant.

### PRESENTATION OF THE INVENTION

It is an object to provide a device of this type with a sufficiently stable shelf access device.

This object is achieved by the storage device of the independent claims.

According to the invention an upper and a lower guide are provided, between which the vertical guide is arranged.

In a first aspect of the invention the longitudinal drive for displacing the vertical guide along the horizontal guides comprises upper and lower drive means. The upper drive means serve to drive the vertical guide along the upper horizontal guide, while the lower drive means serve to drive the vertical drive along the lower horizontal guide. By driving the vertical guide at its upper and lower end section, a tilting of the same while accelerating and decelerating can be avoided even if the vertical guide is built in comparatively light and/or long manner.

In a second aspect of the invention the vertical guide is mounted, in its upper and lower end section, in non-pivotal manner on the upper and the lower horizontal guide, such that a torsion of the vertical guide (16) is avoided. The term “non-pivotal” is to be understood such that the respective end of the vertical guide cannot rotate in respect to the respective horizontal guide about a vertical rotational axis. This measure again improves the stability of the vertical guide, which allows a simple and therefore lighter construction.

In a third aspect of the invention the vertical pillars of the shelf racks are tightly connected to the shelves such that a mutual bracing and stabilisation is achieved.

In a forth aspect the invention relates to a climate control cabinet with an automatic storage device for laboratory objects, in particular microtiter-plates, with at least one storage rack and a shelf access device. The storage rack comprises several storage positions arranged above each other for receiving laboratory objects. The shelf access device comprises at least one drive for a vertical and/or horizontal movement. The drive comprises a gear engaging a cograil. Using cograils in climate controlled cabinets is advantageous because cograil-drives operate flawlessly in a wide temperature range. This is not necessarily the case e.g. with belt drives.

The invention relates to a climate controlled cabinet with a corresponding storage device.

### SHORT DESCRIPTION OF THE FIGURES

Further embodiments, advantages and applications of the invention are given in the dependent claims as well as in the following description, which refers to the figures. These show:

FIG. 1 a view of a climate controlled cabinet with storage device according to the invention,

FIG. 2 a schematic, horizontal sectional view of the climate controlled cabinet of FIG. 1,

FIG. 3 an embodiment of the storage device, where only four storage racks are drawn,

FIG. 4 a detailed view of the shelf access device,

FIG. 5 a part of a storage rack,

FIG. 6 a view of a transparently shown storage rack,

FIG. 7 an enlarged view of a transparently shown storage rack,

FIG. 8 a second embodiment of the shelf access device,

FIG. 9 a schematical representation of the torsion and tilting stabilisator of a second embodiment of the shelf access device,

FIG. 10 a schematic representation of the device of FIG. 9 as seen in longitudinal direction of the storage alley,

FIG. 11 a first alternative embodiment of the device of FIG. 10 and

FIG. 12 a second alternative embodiment of the device of FIG. 10.

### WAYS FOR CARRYING OUT THE INVENTION

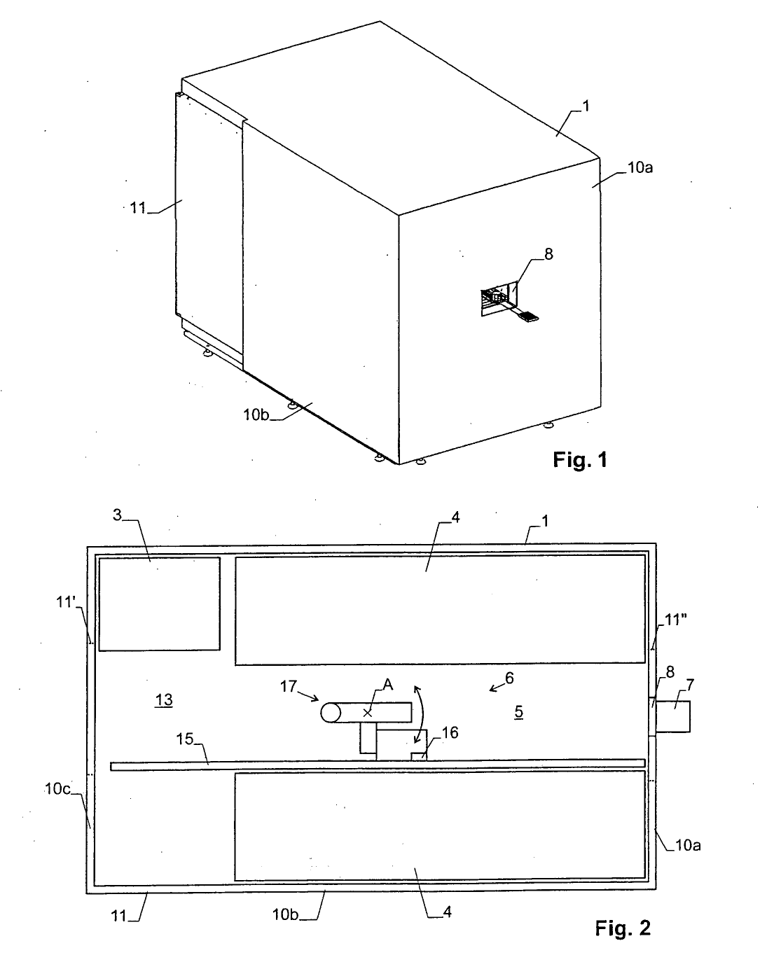

The climate controlled cabinet of FIGS. 1 and 2 comprises a housing 1, in whose interior space a control unit 3 with control and climate generator and a storage device are arranged. The storage device comprises two shelf racks 4, which are arranged on both sides of a storage alley 5. A shelf access device 6 runs along the storage alley 5, by means of which all laboratory objects in the shelf racks 4 can be accessed automatically.

At one end of the climate controlled cabinet, in the extension of the storage alley 5, a transfer station 7 is arranged. It serves for temporarily receiving individual laboratory objects during a transfer between the pickup device 17 of the shelf access device 6 and an external trans-port system. The transfer device 7 consists e.g. of a support table mounted to a wall 10a of the climate controlled cabinet for receiving the laboratory objects and is arranged at an automatic door 8 in the wall 10a of the storage cabinet. The size of the automatic door 8 corresponds approximately to the size of the laboratory objects to be transferred, such that climate losses when opening the door 8 remain small.

The automatic door 8 can also be arranged in the wall 10c opposite to the wall 10a.

At the end of the storage cabinet opposite to the automatic door 8, in a second wall lob parallel to the storage alley 5, a further access door 11 is provided. Through this door, which opens outwards, the users can gain access to the climate controlled cabinet. The door leads to a antechamber 13, which is formed between the shelf racks 4 and the third wall 10c opposite the shelf racks 4. The control unit 3 is arranged in this antechamber 13.

In the embodiment of FIG. 2 the access door 11 is arranged in the second wall 10b. Alternatively or in addition hereto the door can also be arranged in a wall extending transversely to storage alley 5, e.g. in the first wall 10a or in the third wall 10c opposite to the first wall 10a, advantageously in the extension of the storage alley 5, as it is shown in FIG. 2 in dashed lines with reference no. 11′ and 11″, respectively. If the access door is arranged in position 11″ in the first wall 10a, the automatic door 8 is advantageously arranged in the access door.

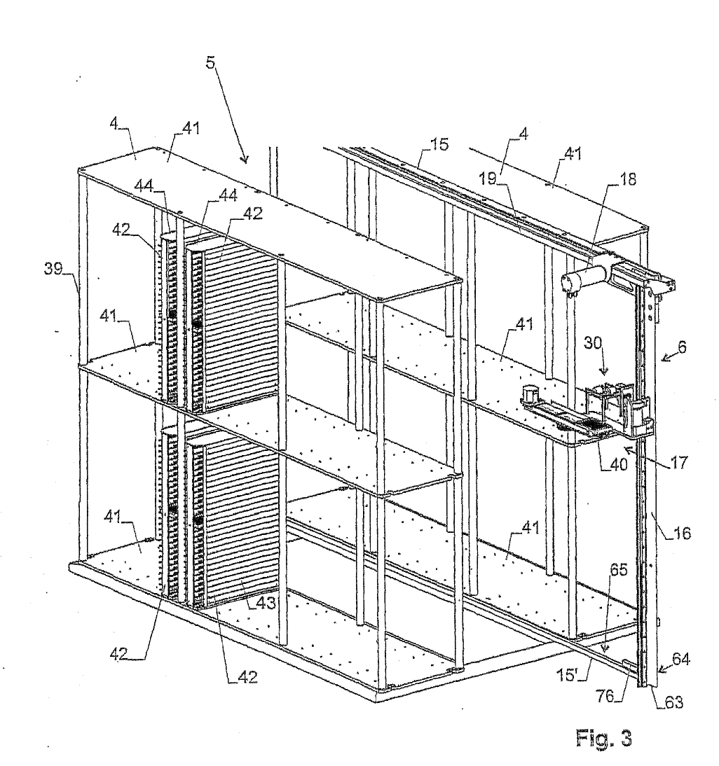

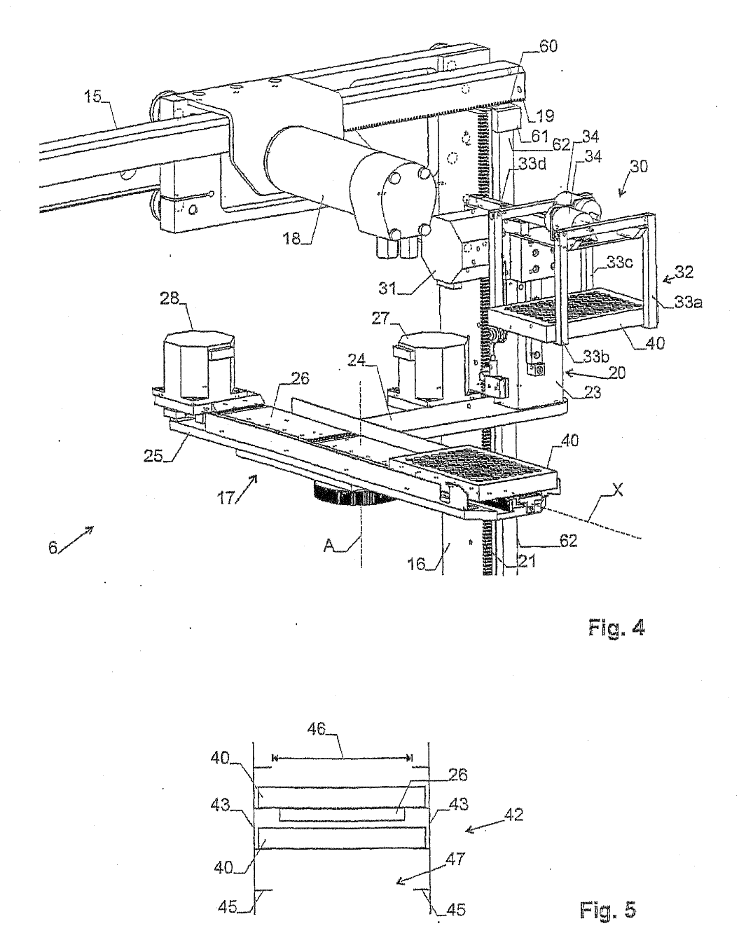

The design of the storage device is best seen from FIGS. 3 and 4. As mentioned, it comprises two shelf racks 4 along the storage alley 5. The shelf access device 6 comprises a stationary, upper horizontal guide 15 in the shape of a horizontal profile track, which is arranged parallel to storage alley 5 in the ceiling section of the climate controlled cabinet. A vertical guide 16 in the form of a vertical profile track is guided on the upper horizontal guide 15. The vertical guide 16 is arranged at the upper horizontal guide 15 and extends downwards from the same. A further, stationary, lower horizontal guide 15′ is provided at the lower end 63 of the vertical guide 16. A pickup device 17 is mounted to the vertical guide 16.

A horizontal drive 18 mounted to the upper end of the vertical guide 16 serves to move the vertical guide 16 along the upper horizontal guide 15 and drives a gear engaging a cograil 19 of the upper horizontal guide 5.

The movement of the vertical guide 16 in respect to the upper horizontal guide 15 is picked up by a gear 60. The gear 60 is rotationally mounted to the vertical guide 16 and engages the cograil 19 of the upper horizontal guide 15. When the vertical guide 16 moves along the upper horizontal guide 15, the gear 60 is therefore rotated. A transmission 61 transfers this rotation to a shaft 62, which extends along the vertical guide 16 to its lower end 63 (see FIG. 3). The shaft 62 is rotatably mounted to the vertical guide 16 and moves along with the same in horizontal direction. At the lower end 63 of the vertical guide 16 the shaft 62 drives a lower gear 64 (not directly visible in FIG. 3). The lower gear engages, as a driving gear, a cograil 65 (also not directly visible in FIG. 3), which runs along the lower guide 15′. Hence, during a horizontal movement of the vertical guide 16, a drive force is not only generated between the upper horizontal guide 15 and the vertical guide 16, but also between the lower horizontal guide 15′ and the vertical guide 16. The transmission ratio between the upper gear 60 and the lower gear 64 is chosen such that the same running speed is enforced at both cograils 19 and 65. Thus, both ends of the vertical guide 16 are guided and driven in controlled manner. This prevents a tilting of the vertical guide 16 while accelerating and decelerating. The vertical guide can therefore be designed in lighter and more compact manner.

A vertical drive 20 (in FIG. 4, rear part 23 hidden) connected to the pickup device 17 serves to displace the pickup device 17 along the vertical guide 16, and drives a gear that engages a cograil 21 of the vertical guide 16.

A vertical column 23 is provided for holding the pickup device 17, which column is connected at its lower end to a horizontal holding arm 24. An elongate table 25 is mounted to the end of the holding arm 24 opposite to column 23. The table 25 can be pivoted in respect to the holding arm 24 about the vertical axis A. As can be seen from FIG. 2, the axis A is approximately in the centre of the storage alley. A pivotal drive 27 serves to pivot the table 25 in respect to the holding arm 24 (and therefore in respect to the vertical guide 16) about the axis A.

An elongate carrier 26 is arranged on the table 25 and displaceable along the longitudinal axis of the table. An extension drive 28 is provided on the table 25 for moving the carrier 26. Table 25 and carrier 26 form, together, the pickup device 17, which is pivotal about axis A and extendable along an extension direction X.

Further, a separating device 30 is arranged on the column 23. The separating device 30 can be driven by means of a first separating drive 31 vertically along column 23. It comprises a gripper 32 for laterally engaging the laboratory object. The gripper 32 comprises at least two, preferably four, fingers 33a-33d extending downwards, which can be horizontally moved against each other by means of a second separating drive 34.

The separating device 30 is located, as seen in longitudinal direction of the storage alley 5, either before or behind the pivotal axis A.

The pickup device 17 can be pivoted, by means of the pivotal drive 28, into three positions. In a transfer position, which is shown in FIG. 3, it can be extended parallel to the storage alley 5. In this position the slightly extended carrier 26 is located below the separating device 30. Depending how far the carrier 26 is extended horizontally, each of the laboratory objects 40 present on the carrier 26 can be brought into the operating range of the separating device 30. The separating device can be lowered vertically onto such a laboratory object 40, such that it can laterally engage the laboratory object 40 with the grippers 32 and lift it. Also it can deposit, in this manner, a laboratory object onto a free space on the carrier 26.

Also, in the transfer position the pickup device 17 can transfer laboratory objects and/or covers through the door 8 to the transfer station 7 or pick them up from the same.

From the transfer position the pickup device can, as shown by a double arrow in FIG. 2, be pivoted to the left or right, in each direction by about 90°, into an exchange position, in which it can be extended against one of the shelf racks 4. FIG. 4 shows the pickup device 17 in exchange position. In this position the pickup device 17 can deposit laboratory objects in the manner described below in the shelf racks 4 or take them up from the same.

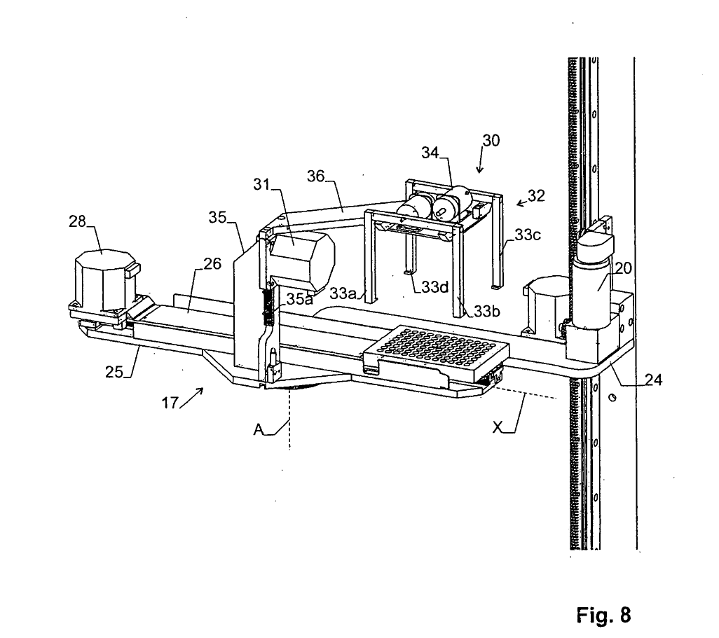

A second embodiment of the pickup device 17 is shown in FIG. 8. It differs from the first embodiment by the fact that the separating device 30 is not stationary in respect to holding arm 24, but stationary in respect to table 25, i.e. it can be pivoted together with table 25. For this purpose a column 35 with a vertical cograil 35a is arranged on table 25. The gear of the vertically displaceable first separating drive 31 engages the cograil 35a. A carrier arm 36 is mounted to the first separating drive 31 and carries the gripper 32. The gripper 32 is built in substantially the same manner as the gripper of the first embodiment.

The method of operation of the embodiment of FIG. 8 corresponds substantially to the one of FIG. 4, in that the gripper 32 can be lowered from above onto the carrier 26 in order to pick up a laboratory object or cover there or to deposit the same. Since the separating device 30 can be pivoted together with the table 25, the embodiment of FIG. 8 has, however, the advantage that the separating device 30 can access the laboratory objects on the carrier 26 in each pivotal position, which allows a quicker processing of orders.

The design of the shelf racks 4 is best seen in FIG. 3. Each shelf rack 4 comprises a frame 39 with, in the present embodiment, three shelves 41. The single-piece shelves (41) are tightly connected to the vertical pillars (39) of their respective shelf rack 4, e.g. screwed thereto, by means of which the shelf rack is stabilized. The upper horizontal guide 15 is mounted to the uppermost shelf 41 of one of the shelf racks, while the lower guide 15′ is mounted to the bottommost shelf 41 of the shelf rack. Storage racks 42 rest on the two lower shelves 41 of each shelf rack 4, only four of which are shown in FIG. 3. Each storage rack 42 comprises two vertical lateral walls 43, which are connected at their upper and lower edges by means of horizontal plates 44.

A part of a storage rack 42 is shown in FIG. 5. As can be seen therefrom, inwards extending ribs are provided on the lateral walls 43 at regular intervals, which form supports 45 for the laboratory objects 40 to be received. Each laboratory object 40 is inserted into the storage rack 42 in such a manner that opposite lower edge regions of the laboratory object are each supported by one support or rib 45. Thus, each storage rack 42 has a vertical row of storage positions 47 defined by the ribs 45. The depth of the storage rack 42 is such that in each storage position 47 several laboratory objects find room behind each other. The width and height of the storage positions 47 is adapted to the dimensions of the respective laboratory objects to be received.

The storage racks 42 are self-supporting units, and each storage rack can, with any laboratory object stored therein, be withdrawn as a whole from the storage device or climate controlled cabinet.

A gap 46 is provided between opposite supports or ribs 45, which is wider than the extendible carrier 26. The bottom side of the laboratory object 40 is freely accessible in the region of this gap 46. In order to engage the laboratory objects, the pickup device or the carrier 26 can be inserted into the gap 46.

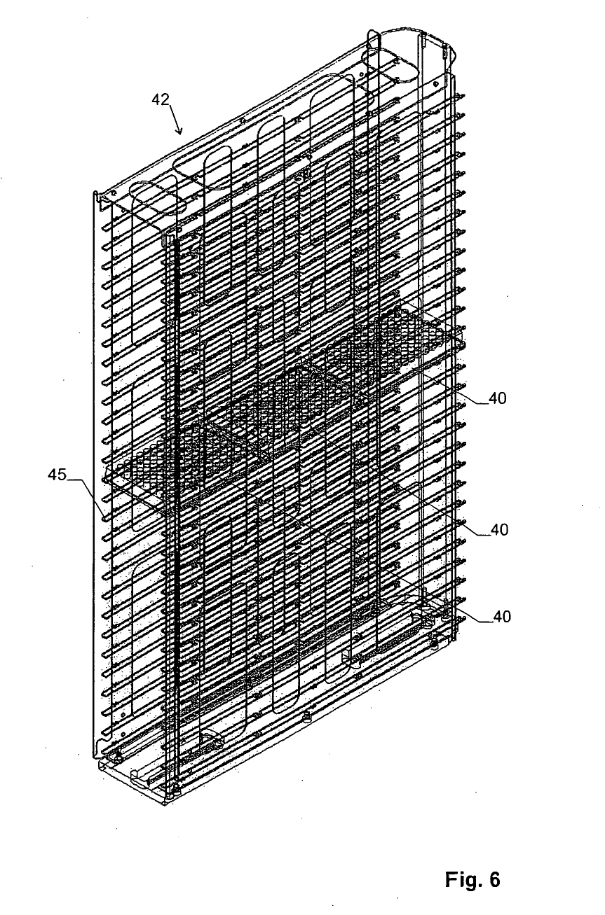

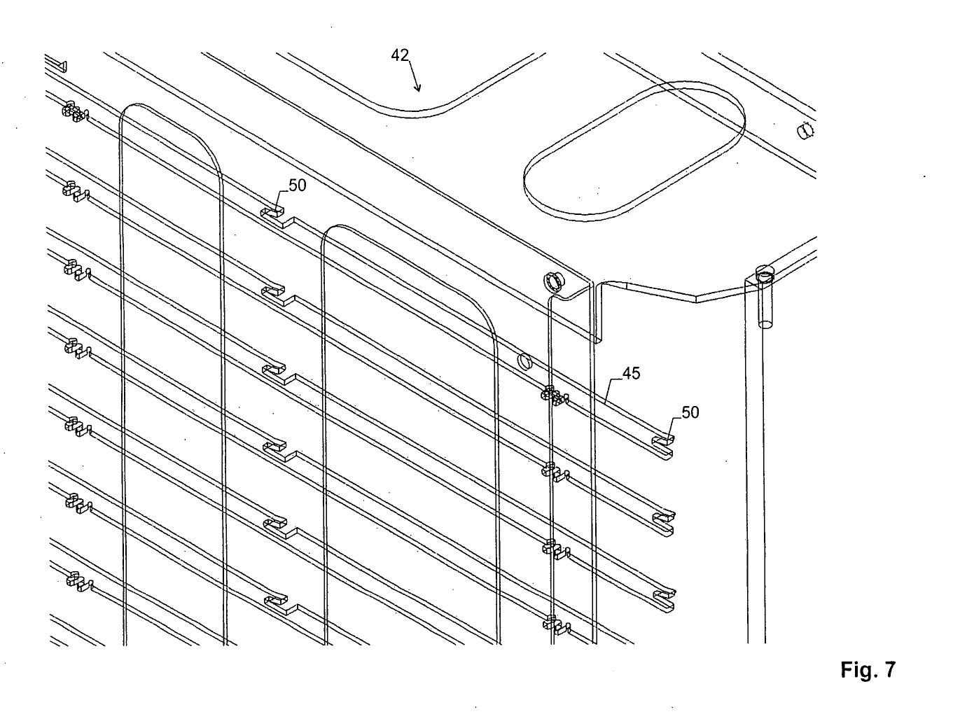

FIGS. 6 and 7 show a specific embodiment of a storage rack 42. In particular in FIG. 6, three laboratory objects 40 or microtiter-plates arranged behind each other can be seen, which rest in three storage locations behind each other on the supports or ribs 45. In order to hold the laboratory objects 40 in longitudinal direction of the storage position 47 in defined manner and to prevent them from shifting, each storage location comprises holding means 50, by means of which the respective laboratory object can be held in longitudinal direction of the storage position 47. The holding means 50 are formed, in the embodiment of FIGS. 6 and 7, by projections, which extend upwards from the supports 45. The projections are formed by upwardly bent tongues of the metal sheet supports 45.

The function of the described device is as follows:

In order to withdraw a given laboratory object from a known position in the shelves 4 of the storage device, the pickup device 17 is pivoted into the exchange position and horizontally and vertically displaced in such a manner that it is located in front of the storage position 47 of the given laboratory object, namely such that the upper side of the carrier 26 is somewhat lower than the bottom side of the laboratory object. Then, the carrier 26 is extended into the shelf rack 4 and lifted, by means of the vertical drive 20, until it enters the gap 46 and lifts all of the laboratory objects arranged behind each other on the ribs 45 of the respective storage position 47. Now the carrier 26 is again retracted and the pickup device 17 is pivoted into the transfer position. In this intermediate storage position the carrier 26 is extended so far that the laboratory object 40 to be withdrawn comes to lie exactly below the separating device 30. Now the separating device 30 is lowered, engages the laboratory object 40 and lifts the same. After having removed the desired laboratory object 40 in this manner from the pickup device 17, the pickup device 17 is pivoted back to the exchange position, extended into the shelf rack and lowered somewhat, such that the remaining laboratory objects are again deposited in their storage position 47. The now empty carrier 26 is retracted, pivoted into the transfer position and extended so far that its end section lies below the separating device 30. The separating device is again lowered and releases the previously withdrawn laboratory object 40 onto the carrier 26. Now the pickup device 17 can be driven to the door 8. The door 8 is opened and the carrier 26 is extended and lowered such that it deposits the laboratory object in the transfer position 7.

To deposit an individual laboratory object 40 at a given position in the shelf racks 4, the reverse process is used. The pickup device 17 drives to the door 8, the carrier 26 is extended and lifts the laboratory object 40 furnished at the transfer position 7. The carrier 26 is retracted. The laboratory object 40 is brought into the region of access of the separating device 30, which removes it from carrier 26. The pickup device 17 is driven to the desired storage position 47 and pivoted to the exchange position. The carrier 26 extends, lifts the laboratory objects already present in the storage position 47, retracts and pivots to the transfer position. It is extended horizontally so far that a free space of the table comes to rest below the separating device 30, whereupon the separating device 30 deposits the new laboratory object there. Then all laboratory objects on the carrier 26 are placed back into the shelf rack, for which purpose the carrier 26 pivots back into the exchange position, extends, is lowered, and deposits the laboratory objects 40 on the supports or ribs 45. Then the carrier 26 is again retracted.

In order to reach a higher transfer capacity, it is also possible to handle several laboratory objects 40 at the same time on table 25. For example the carrier 26 can withdraw three laboratory objects behind each other from a shelf position and bring them, together, to the transfer position 7, where the laboratory objects are taken over or handled together. In opposite manner several storage objects can be brought from the transfer position 7 in a single working step, together, to a storage position and deposited there behind each other.

It is further possible, that the separating device 30 is able to temporarily store several laboratory objects at the same time. For example, it can pick up several laboratory objects, which are then received by the transfer position 7. For this purpose the transfer position must be provided by means for directly receiving the laboratory objects from the separating device 30.

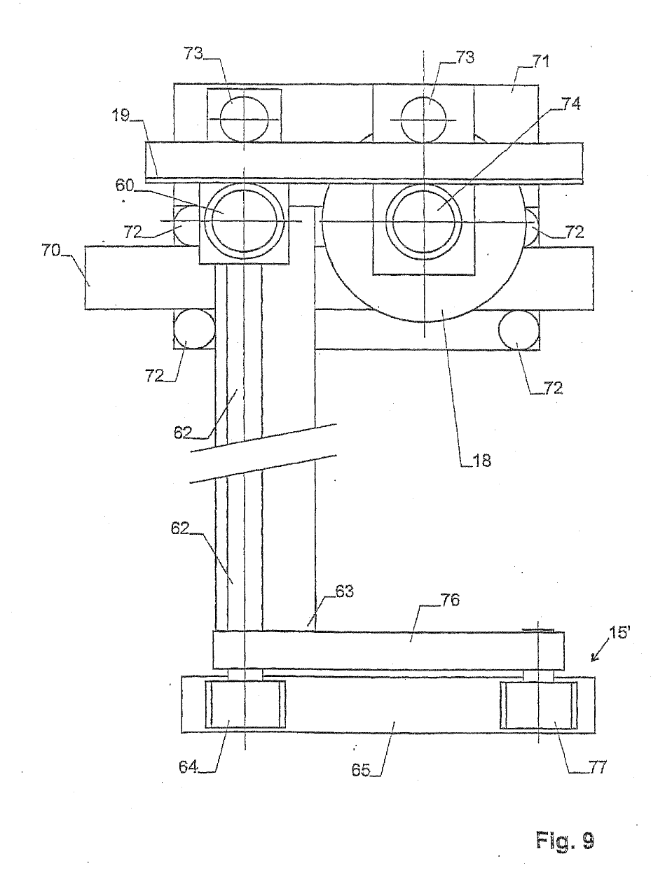

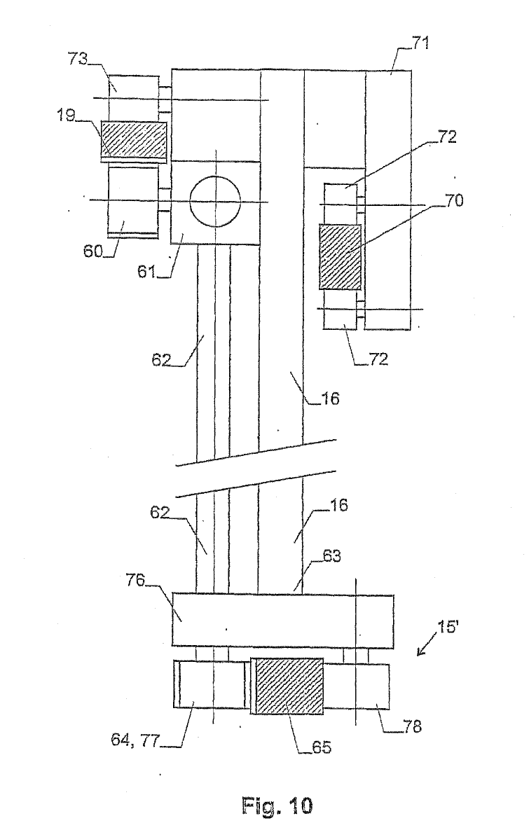

FIGS. 9 and 10 show a further embodiment of the longitudinal drive of the device according to the invention. In FIG. 9 the upper horizontal guide 15 consists, on the one hand, of a guide rail 70 and, separate therefrom, on the other hand, of a cograil 19. The vertical drive 16 and a carriage 71 connected thereto is guided on the guide rail 70 by means of four rollers 72. The carriage 71 also carries the upper gear 60 as well as the horizontal drive 18 as well as two pressure rollers 73, one of which is opposite to upper gear 60 and the other to drive gear 74 of the horizontal drive 18.

The rotation of the upper gear 60 is, as in the first embodiment of FIGS. 3 and 4, transmitted to the shaft 62 by means of the transmission 61. From the shaft 62 the rotation is transferred directly, i.e. without further deflection, to the lower gear 64, which engages the cograil 65 of the lower horizontal guide 15′.

Hence, the described device, as the one of FIGS. 3 and 4, has a horizontal drive with upper and lower drive means. The upper drive means, comprising the horizontal drive 18 and its gear 74, drive the vertical guide 16 along the upper horizontal guide 15. The lower drive means, comprising the gear 60, the transmission 61, the shaft 62 and the gear 64, drive the vertical drive 16 along the lower horizontal guide 15′. The two guide means are coupled by means of shaft 62 and work synchronously in order to prevent a tilting of the vertical guide 16.

As can in particular be seen from FIG. 9, a foot 76 is arranged at the lower end 63 of the vertical guide 16. (A corresponding foot 76 can also be seen in the embodiment of FIG. 3.) The foot 76 is rigidly connected to the lower end 63 of the vertical guide 16 and runs non-pivotally (in the definition given above) along the lower horizontal guide 15′. This is achieved by providing a second lower gear 77 at the foot 76 at a distance from the first lower gear 64, wherein gear 77 runs on the cograil 65 of the lower horizontal guide 15, as well as two lower pressure rollers 78, a first of which is attributed to the first lower gear 64 and the other to the second lower gear 77 and which press from the opposite side onto cograil 65.

The non-rotational mounting of foot 76 on the lower horizontal guide 15′ prevents a torsion of the vertical guide about its longitudinal axis. Such a torsion can, otherwise, occur in particular if the pickup device 17 is located in the lower region of the vertical guide.

A non-rotational support of the vertical guide 16 is preferably provided at both of its ends. In the present case the carriage 71 also forms such a non-rotational support at the upper end of the vertical guide 16, e.g. by guiding the two pressure rollers 72 in suitable guiding grooves (not shown).

Hence, a non-rotational support is achieved, in the shown embodiments, by the fact that the vertical guide 16 is guided at the upper and the lower horizontal guide 15 and 15′, respectively, by means of at least two spaced apart pairs of pressure rollers and/or gears.

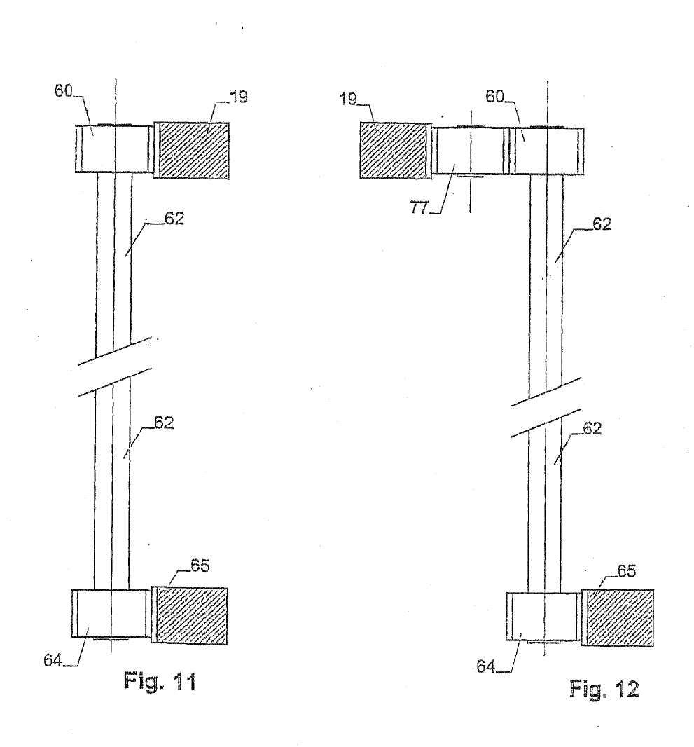

In the embodiment of FIGS. 9 and 10 the teeth of the cograil 19 are arranged at the bottom side of the cograil 19, for which reason the rotational axis of the gear 60 has to be arranged horizontally and a transmission 61 is required for transmitting the rotation from gear 60 to shaft 62. The transmission 61 can be dispensed with if the teeth are arranged on a vertical lateral side of the cograil 19. This is illustrated in FIGS. 11 and 12. If the teeth of the cograil 19 are facing the same side as those of the cograil 65, shaft 62 can directly transmit the rotational motion from the upper gear 60 to the lower gear 64, see FIG. 11. If the teeth of the cograils 19 and 65 are facing opposite directions, a reversing gear 77 is required as shown in FIG. 12.

In the embodiment of FIGS. 9 and 10 the gear 74 of the horizontal drive 18 is running on the same cograil 19 as the gear 60 driving the shaft 62. Depending on the arrangement of gear 74 and of the drive and the gear 60, they can, however, also engage two different cograils of the upper horizontal guide 15.

The embodiment shown here can be adapted in various manner to the respective requirements.

For example a single shelf rack extending along storage alley 5 can be provided instead of two shelf racks 4.

If different types of laboratory objects are to be stored, different storage racks with correspondingly sized storage positions can be provided.

The cograils 19, 21, 35a, 65 used in the embodiments can also be replaced by belt drives. However, belt drives are not well suited for wide temperature ranges, such as from −20° C. to +70° C. as they can exist in a climate controlled cabinet, for which reason it is preferred to use cograils and corresponding driving gears.

In the shown embodiments the horizontal drive 18 is arranged at the upper horizontal guide 15. Depending on available space it can also be arranged at the lower horizontal guide 15′. In this case shaft 62 transmits the driving energy from the bottom to the top.

It is also possible to provide two separate, synchronously operated horizontal drives, one of which drives the vertical guide 16 at the upper horizontal guide 15. The other drives the vertical guide 16 at the lower horizontal guide 15′. In this case shaft 62 can be dispensed with.

While the present application describes preferred embodiments of the invention, it is to be distinctly pointed out that the invention is not limited thereto, but can also be carried out in different manner within the scope of the following claims.

1. Automatic storage device for laboratory objects, in particular microtiter-plates, with
at least one shelf rack arranged along a storage alley for receiving the laboratory objects and
a shelf access device, which comprises
a pickup device displaceable along the storage alley,
at least one horizontal guide and
a vertical guide arranged on the horizontal guide, wherein the pickup device is arranged in vertically displaceable manner on the vertical guide, and wherein there is further provided a longitudinal drive for moving the vertical guide along the horizontal guide,
wherein there are provided an upper and a lower horizontal guide, wherein the upper horizontal guide is arranged in an upper end section of the vertical guide and the lower horizontal guide is arranged in a lower end section of the horizontal guide, and
wherein the longitudinal drive comprises upper and lower drive means, wherein the upper drive means are designed for driving the vertical guide on the upper or horizontal guide and the lower drive means are designed for driving the vertical on the lower horizontal guide.

2. Storage device of claim 1 wherein the upper and the lower drive means drive the vertical guide synchronously.

3. Storage device of claim 1 wherein the drive means are coupled by means of a shaft extending between the end sections of the vertical guide.

4. Storage device of claim 1 wherein the upper and the lower vertical guides each comprise a cograil, wherein the upper and the lower drive means each engage the respective cograil by means of a driving gear.

5. Storage device of claim 4, wherein the drive means are couple by means of a shaft extending between the end sections of the vertical guide, and
wherein a horizontal drive is provided, which engages the cograil of a first of the horizontal guides by means of a first driving gear, and the shaft is driven by means of a gear by the first horizontal guide and a second of the drive gears.

6. Automatic storage device for laboratory objects with
at least one shelf rack arranged along a storage alley for receiving the laboratory objects and
a shelf access device, which comprises a pickup device displaceable along the storage alley, wherein the shelf access device comprises at least one horizontal guide and a vertical guide guided along the horizontal guide, wherein the pickup device is arranged in vertically displaceable manner on the vertical guide and wherein there is further provided a longitudinal drive for moving the vertical guide along the horizontal guide,
wherein an upper and a lower horizontal guide are provided, wherein the upper horizontal guide is arranged in a upper end section of the vertical guide and the lower horizontal guide is arranged in a lower end section of the vertical guide, and wherein the vertical guide is supported in non-rotational manner on the upper and the lower horizontal guide, such that a torsion of the vertical guide is prevented.

7. Storage device of claim 6, wherein the vertical guide is guided on each of the upper and the lower horizontal guide by means of at least two spaced apart pairs of pressure rollers and/or gears.

8. Storage device of claim 1 with a pivotal drive for pivoting the pickup device in respect to the vertical guide.

9. Storage device of claim 1 wherein shelf racks are arranged on both sides of the storage alley.

10. Storage device of claim 1, wherein the pickup device is designed for manipulating individual microtiter-plates.

11. Climate controlled cabinet with a storage device of claim 1.

12. Climate controlled cabinet with an automatic storage device for laboratory objects with
at least one shelf rack arranged along a storage alley for receiving the laboratory objects and
a shelf access device comprising a pickup device horizontally and vertically displaceable in the storage alley,
wherein the shelf rack comprises vertical pillars fixedly connected to one or more shelves.

13. Climate controlled cabinet of claim 12, wherein several shelves are provided for each shelf rack.

14. Climate controlled cabinet of claim 12 wherein each shelf is of a single piece.

15. Climate controlled cabinet of claim 12 wherein at least a part of the shelves carries storage racks, wherein each storage rack comprises several storage positions above each other for receiving laboratory objects.

16. Climate controlled cabinet with an automatic storage device for laboratory objects with
at least one storage rack and
a shelf access device,
wherein the storage rack comprises several storage positions arranged on top of each other for receiving laboratory objects and the shelf access device comprises at least one drive for a vertical and/or horizontal movement,
and wherein the drive comprises a gear engaging a cograil.

17. Climate controlled cabinet of claim 16, wherein the shelf racks comprise storage racks with storage positions with several storage locations behind each other, wherein each storage location is designed for receiving a laboratory object and comprises holding means by means of which the respective laboratory object can be held in a longitudinal direction of the storage position,

18. Climate controlled cabinet of claim 17 wherein each storage position comprises two supports extending parallel and at the same height, for supporting opposite edge sections of the laboratory objects in the storage position, and wherein the holding means are formed by projections, which project upwards from the supports.

19. The storage device of claim 3 wherein the shaft moves along with the vertical guide.

20. The storage device of claim 6 wherein the laboratory objects are microtiter-plates.

21. The climate controlled cabinet of claim 12 wherein the laboratory objects are microtiter-plates.

22. The climate controlled cabinet of claim 16 wherein the laboratory objects are microtiter-plates.
